(19) United States
(12) Patent Application Publication
(10) Pub. No.: US 2026/0017158 A1
(43) Pub. Date: Jan. 15, 2026

(54) MANAGEMENT APPARATUS, PATH SETTING METHOD, AND PATH SETTING PROGRAM

(71) Applicant: Hitachi Vantara, Ltd., Yokohama-shi (JP)

(72) Inventors: Misato YOSHIDA, Tokyo (JP); Takahiro YAMAMOTO, Tokyo (JP); Taisuke ONO, Tokyo (JP)

(21) Appl. No.: 19/077,466

(22) Filed: Mar. 12, 2025

(30) Foreign Application Priority Data
Jul. 11, 2024 (JP) 2024-112019

(51) Int. Cl. G06F 11/20

(52) U.S. Cl. CPC G06F 11/2089; G06F 2201/805

(57) ABSTRACT

In a management node that manages a path between a primary storage system and a secondary storage system in a computer system, the secondary storage system includes a first node having a first SCS that processes copying in a unit of copy and a second node having a second SCS that performs a copy process in place of the first SCS when a failure occurs in the first SCS, the management node includes a processor, and the processor calculates a necessary number of paths, which is the number of paths necessary for a performance requirement, on the basis of quality of a network between the primary storage system and the secondary storage system and the performance requirement related to a communication amount necessary for copying in a unit of copy, and sets the necessary number or more of paths between the primary storage system and the first node.

### CROSS-REFERENCE TO RELATED APPLICATION

The present application claims priority from Japanese application JP2024-112019, filed on Jul. 11, 2024, the content of which is hereby incorporated by reference into this application.

### BACKGROUND OF THE INVENTION

### 1. Field of the Invention

The present invention relates to a technique of setting a path between storage systems that perform remote copy.

### 2. Description of the Related Art

In order to protect data, remote copy is performed between the storage system (primary storage system) at the primary site and the storage system (secondary storage system) at the secondary site. The remote copy is executed, for example, in units of journal groups (JNLG). The journal group includes one or more data volumes that store data and one or more journal volumes that store a journal indicating a change history with respect to the data volume. Consistency is guaranteed for multiple data volumes belonging to the same JNLG.

When JNLG is copied between the primary storage system and the secondary storage system, a path is selected and used from a path group including one or more communication paths (paths) of data between the primary storage system and the secondary storage system.

As a technique related to remote copy between the primary storage system and the secondary storage system, for example, a technique described in WO 2016/194096 is known.

### SUMMARY OF THE INVENTION

For example, in order to copy the JNLG, in a case where a sufficient number of paths are not set in the path group to be used, the communication amount necessary for the remote copy of the JNLG cannot be realized, and there is a possibility that the remote copy of the JNLG cannot be appropriately executed.

The present invention has been made in view of the above circumstances, and an object thereof is to provide a technique capable of appropriately setting a path between a primary storage system and a secondary storage system.

In order to achieve the above object, a management apparatus according to one aspect manages a path between a first storage system and a second storage system in a computer system including the first storage system and the second storage system that is a copy destination of a predetermined unit of copy of the first storage system. The second storage system includes a first node having a first controller that processes copying in the unit of copy and a second node having a second controller that performs a copy process in place of the first controller when a failure occurs in the first controller. The management apparatus includes a processor. The processor is configured to execute: calculating a necessary number, which is a number of paths necessary for a performance requirement, based on quality of a network between the first storage system and the second storage system and a performance requirement related to a communication amount necessary for copying in the unit of copy; and setting the necessary number or more of paths between the first storage system and the first node.

According to the present invention, it is possible to appropriately set a path between storage systems that perform remote copy.

### BRIEF DESCRIPTION OF THE DRAWINGS

FIG. 1 is a schematic diagram illustrating an outline of an embodiment;

FIG. 2 is a diagram illustrating a hardware configuration of a computer system according to an embodiment;

FIG. 3 is a schematic diagram illustrating an outline of a remote copy configuration according to an embodiment;

FIG. 4 is a schematic diagram illustrating an outline of a remote copy process according to an embodiment;

FIG. 5 is a schematic diagram illustrating an outline of a recovery process from a node failure according to an embodiment;

FIG. 6 is a diagram of a configuration of a memory of a storage node according to an embodiment;

FIG. 7 is a diagram illustrating a configuration of a system configuration management table according to an embodiment;

FIG. 8 is a diagram illustrating a configuration of a pair configuration management table according to an embodiment;

FIG. 9 is a diagram illustrating a configuration of a path management table according to an embodiment;

FIG. 10 is a diagram of a configuration of a remote copy processing performance management table according to an embodiment;

FIG. 11 is a diagram of a configuration of an operating environment constraint condition management table according to an embodiment;

FIG. 12 is a diagram illustrating a configuration of a memory of a management node according to an embodiment;

FIG. 13 is a diagram of a configuration of an NW quality and path performance management table according to an embodiment;

FIG. 14 is a diagram illustrating a configuration of a path number management table according to an embodiment;

FIG. 15 is a flowchart of a remote copy preparation process according to an embodiment;

FIG. 16 is a diagram of a configuration of copy target volume information according to an embodiment;

FIG. 17 is a flowchart of a remote copy configuration construction process according to an embodiment;

FIG. 18 is a diagram illustrating a JNLG arrangement design example according to an embodiment;

FIG. 19 is a flowchart of a remote copy process according to an embodiment;

FIG. 20 is a flowchart of a failover process according to an embodiment;

FIG. 21 is a flowchart of a path number update process according to an embodiment;

FIG. 22 is a schematic diagram illustrating a state after failover according to an embodiment;

FIG. 23 is a schematic diagram illustrating an outline of dynamic addition of a standby path according to an embodiment;

FIG. 24 is a schematic diagram illustrating a state after dynamic addition of a standby path according to an embodiment;

FIG. 25 is a schematic diagram illustrating an outline of a path number update process at the time of an NW quality change according to an embodiment; and

FIG. 26 is a schematic diagram illustrating an outline of a path number update process according to an actual IO load according to an embodiment.

### DESCRIPTION OF THE PREFERRED EMBODIMENTS

Embodiments will be described with reference to the drawings. Further, the embodiments described below do not limit the scope of the invention. Not all the elements and combinations thereof described in the embodiments are essential to the solution of the invention.

In the following description, an “interface device” may represent one or more communication interface devices. The one or more communication interface devices may be one or more communication interface devices of the same type (for example, one or more NICs (Network Interface Card)), or may be two or more communication interface devices of different types (for example, NIC and HBA (Host Bus Adapter)).

Further, in the following description, a “memory” is one or more memory devices that are examples of one or more storage devices, and may typically be a main memory device. At least one memory device in the memory may be a volatile memory device or a non-volatile memory device.

Further, in the following description, a “persistent storage device” may be one or more persistent storage devices that are examples of one or more storage devices. The persistent storage device may typically be a non-volatile storage device (for example, auxiliary storage device), and specifically, for example, a Hard Disk Drive (HDD), a Solid State Drive (SSD), or a Non-Volatile Memory Express (NVMe) drive may be used.

Further, in the following description, a “processor” may be one or more processor devices. At least one processor device is typically a microprocessor device such as a Central Processing Unit (CPU), or may be other types of processor devices such as a Graphics Processing Unit (GPU). At least one processor device may be configured by a single core, or multiple cores. At least one processor device may be a processor core. At least one processor device may be a processor device such as a hardware circuit (for example, FPGA (Field-Programmable Gate Array), CPLD (Complex Programmable Logic Device), or an ASIC (Application Specific Integrated Circuit)) which performs some or all of the processes in a broad sense.

Furthermore, in the following description, information may be described with an expression of an “AAA table”, but the information may be expressed with any data structure. That is, the “AAA table” can be referred to as “AAA information” to indicate that the information does not depend on the data structure. In the following description, the configuration of each table is given as merely exemplary. One table may be divided into two or more tables, or all or some of two or more tables may be configured by one table.

In addition, in the following description, a process may be described to be performed by a “program”. The program is performed by the processor unit, and a designated process is performed appropriately using at least one of a storage unit and an interface unit. Therefore, the subject of the process may be the processor unit (or a computer or a computer system which includes the processor unit). The program may be installed in the computer from a program source. The program source may be, for example, a program distribution server or a computer-readable recording medium. In addition, in the following description, two or more programs may be expressed as one program, or one program may be expressed as two or more programs.

Further, in the following description, in a case where the same type of elements is referred without distinction, a common portion of the reference symbols may be used. In a case where the same type of elements is described in distinction, the reference numeral or an element identifier may be used. For example, PVOL may be distinguished from other PVOLs using an identifier such as “PVOL 1”.

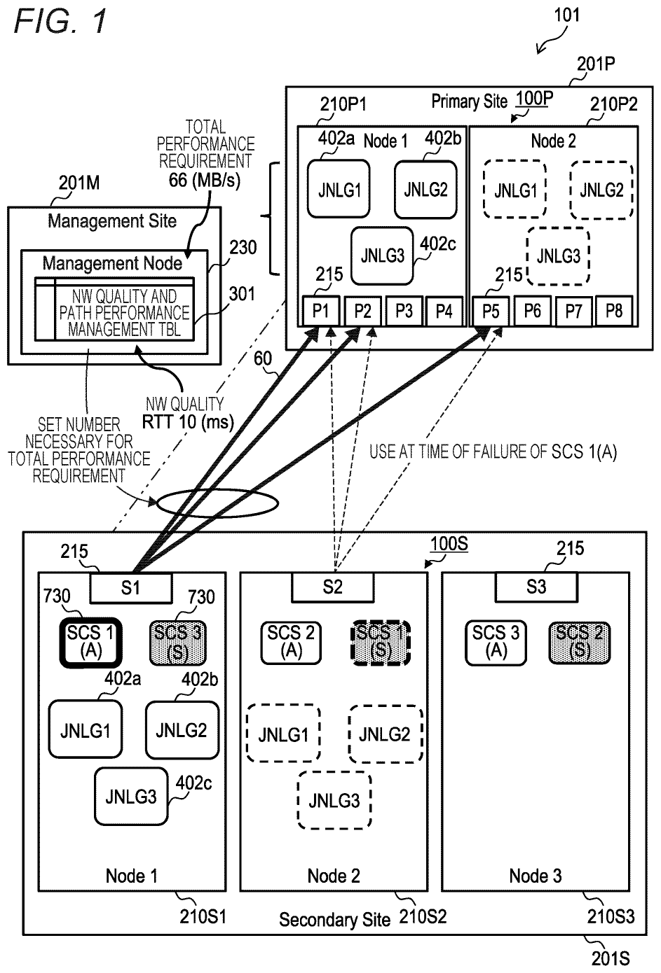

FIG. 1 is a schematic diagram illustrating an outline of an embodiment.

A computer system 101 includes a primary storage system 100P (an example of a first storage system) arranged at a primary site 201P, a secondary storage system 100S (an example of a second storage system) arranged at the secondary site 201S, and a management node 230 (an example of a management apparatus) arranged at a management site 201M. The primary storage system 100P, the secondary storage system 100S, and the management node 230 can communicate with each other via a network (NW). Each site may be an on-premises site or a cloud site. In the present embodiment, for example, the primary site 201P is an on-premises site, and the secondary site 201S is a cloud site. The management node 230 may be disposed in the primary site 201P or the secondary site 201S, or may be configured by a node 210 of the primary site 201P or the secondary site 201S.

The primary storage system 100P includes a plurality of nodes 210 (primary nodes 210P1 and 210P2). The primary storage system 100P may be a so-called disk array system.

The secondary storage system 100S includes a plurality of nodes 210 (secondary nodes 210S1, 210S2, and 210S3). Note that the number of nodes of the primary storage system 100P and the secondary storage system 100S is not limited to the example of the drawing.

The node 210 is typically a general-purpose computer, but may be a physical computer other than the general-purpose computer, or may be a virtual computer. The node 210 includes one or more ports 215, a journal group (JNLG) 402 (402a, 402b, 402c), and storage control software (SCS) 730. In FIG. 1, the SCS is not displayed for convenience in the primary storage system 100P. The JNLG 402 is a unit of remote copy, and includes one or more data volumes that store data and one or more journal volumes that store a journal indicating a change history with respect to the data volume. Here, a functional unit configured by a processor that executes the SCS 730 corresponds to a controller.

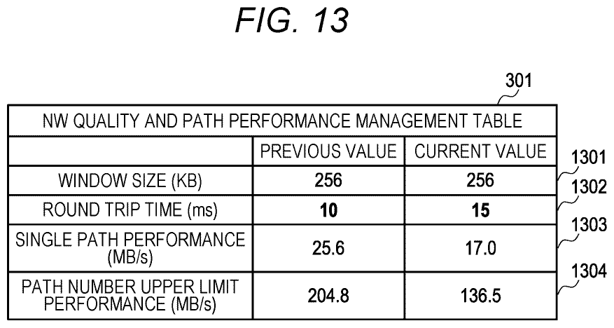

The management node 230 may be a physical computer or a virtual computer. The management node 230 manages the NW quality and path performance management table 301 (see FIG. 13) that stores the communication quality (NW quality) of the network between the primary storage system 100P and the secondary storage system 100S and the performance of the path in the network.

The primary node 210P1 (Node 1) has ports P1 to P4 as the port 215. The primary node 210P1 stores JNLG 1, JNLG 2, and JNLG 3 as the JNLG 402.

The primary node 210P2 (Node 2) has ports P5 to P8 as the port 215. The primary node 210P2 stores copies of the JNLG 1, the JNLG 2, and the JNLG 3 of the primary node 210P1.

Each of the primary storage system 100P and the secondary storage system 100S includes one or more SCS groups. The SCS group includes one active SCS 730 (denoted as active SCS or SCS (A): an example of a first controller) and one or more standby SCSs 730 (denoted as standby SCS or SCS(S): an example of second controller). The SCS (A) and the SCS(S) in the same SCS group are arranged in different nodes 210. In each storage system, in a case where a failure occurs in the node 210 having the SCS (A), instead of the SCS (A), a failover is executed to enable any SCS (S) belonging to the same SCS group to operate as the SCS (A). For example, in the secondary storage system 100S, the SCS x(A) (x is a natural number) and the SCS x(S) constitute an SCS group x, and in a case where a failure occurs in the node 210 having the SCS x(A), a failover from the SCS x(A) in the node 210 to any one of the SCS x(S) in another node 210 is performed.

The secondary node 210S1 (Node 1: an example of a first node) has a port S1 as the port 215, the secondary node 210S2 (Node 2: an example of a second node) has a port S2 as the port 215, and the secondary node 210S3 (Node 3) has a port S3 as the port 215.

In the example of FIG. 1, the JNLG 1, the JNLG 2, and the JNGL 3 of the primary node 210P1 are remotely copied to the secondary node 210S1. In this case, a path for transmitting the data of the JNLG 1, the JNGL 2, and the JNGL 3 from the secondary storage system 100S to the primary storage system 100P is set. The network connection protocol between the secondary storage system 100S and the primary storage system 100P may be any of isCSI, Fibre Channel (FC), NVMe over Fabrics (NVMe-oF), and a vendor-specific unique protocol. For example, in the case of isCSI, the path may be an iSCSI session.

The management node 230 acquires the communication performance requirements (total performance requirements) required for remote copy for the JNLG 1, the JNGL 2, and the JNGL 3 to be subjected to remote copy, refers to the NW quality and path performance management table 301, acquires the NW quality (for example, RTT: Round Trip Time), specifies the communication performance per path on the basis of the NW quality, and determines the number of paths (necessary number) necessary for the total performance requirements. Here, a case where the protocol is iSCSI/TCP and the window size is 256 KB (0.256 MB) will be described as an example. In a case where the RTT is 10 ms, the performance per path is as follows: window size/RTT=0.256 MB/0.010 s=25.6 MB/s. In a case where the total performance requirement is 66 MB/s, the number of necessary paths is 66/25.6=2.578, that is, 3.

Here, assuming that the upper limit number of paths of the path group allocated to the JNLG 1, the JNGL 2, and the JNGL 3 is 8, three paths can be set, and thus, the management node 230 sets three paths from the node 210S1 of the SCS 1(A) that processes the remote copy to the primary storage system 100P. As a result, it is possible to set a path through which remote copy of the JNLG 1, the JNGL 2, and the JNGL 3 can be performed without any trouble.

Further, in this example, since there is a margin of five paths even if three paths are set, the management node 230 causes the node 210S2 having the SCS 1(S) of the same SCS group as the SCS 1(A) to set three paths to the primary storage system 100P. As a result, after a failure occurs in the SCS 1(A) and a failover occurs to the SCS 1(S), remote copy can be immediately executed using the set path.

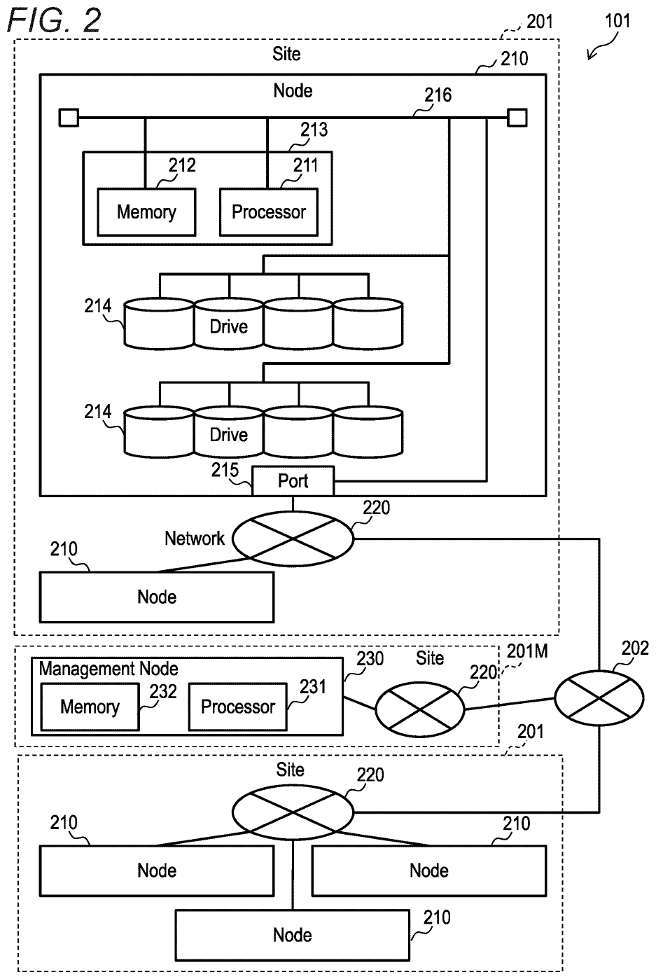

FIG. 2 is a diagram illustrating a hardware configuration of a computer system according to an embodiment.

The computer system 101 includes a plurality of sites 201. Each site 201 is communicably connected via a network 202. The network 202 is, for example, a wide area network (WAN), but is not limited to the WAN. The site 201 is a data center or the like, and includes one or more nodes 210. Note that a site 201M includes the management node 230.

The node 210 may be a general-purpose computer. The node 210 includes, for example, one or more processor packages 213 including a processor 211, a memory 212, and the like, one or more drives 214, and one or more ports 215. The respective components are connected through an inner bus 216. The drive 214 is an example of a persistent storage device.

The processor 211 is, for example, a central processing unit (CPU), and performs various types of processing.

The memory 212 is typically a volatile memory, and stores control information necessary for realizing the function of the node 210 and stores data. In addition, the memory 212 stores, for example, a program executed by the processor 211. The drive 214 stores various data, programs, and the like.

The port 215 is connected to a network 220 in the site 201, and communicably connects the own node to the same site 201, another node 210 in another site 201, and the management node 230 via the network 220. The network 220 is, for example, a local area network (LAN), but is not limited to the LAN.

Note that the physical configuration of the system is not limited to the above-described configuration. For example, the networks 202 and/or 220 may be redundant. Furthermore, for example, the network 220 may be separated into a network for management and a network for storage, the connection standard may be Ethernet (registered trademark), Infiniband, or wireless, and the connection topology is not limited to the configuration illustrated in FIG. 2. Furthermore, for example, the drive 214 may have a configuration independent of the node 210, that is, may be an externally connected drive.

The management node 230 may be a general-purpose computer (computer). The management node 230 includes, for example, a processor 231 and a memory 232.

The processor 231 is, for example, a CPU, and performs various types of processing.

The memory 232 is typically a volatile memory, and stores control information necessary for realizing the function of the management node 230 and stores data. In addition, the memory 232 stores, for example, a program executed by the processor 231.

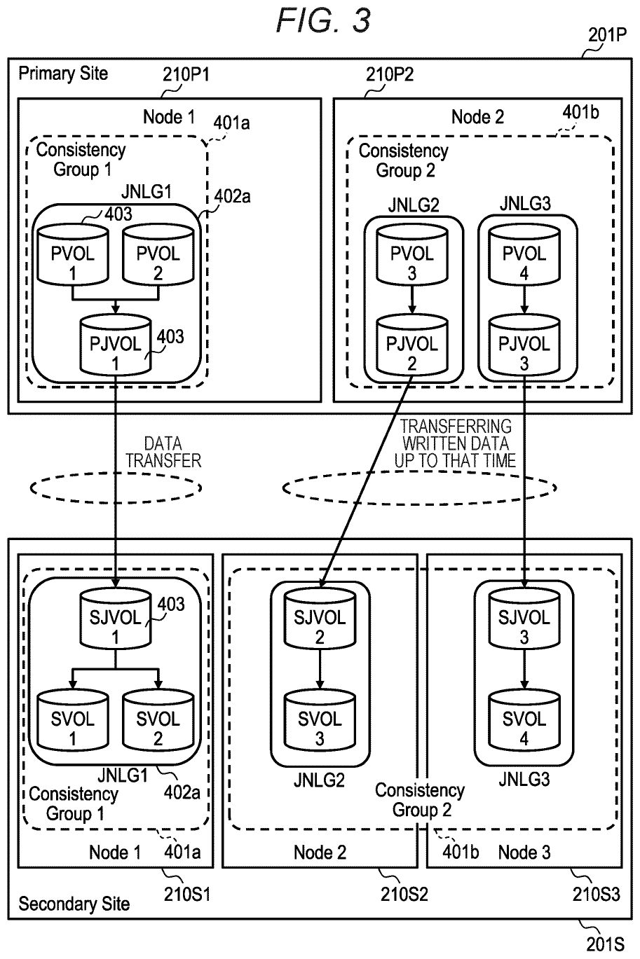

FIG. 3 is a schematic diagram illustrating an outline of a remote copy configuration according to an embodiment.

A plurality of remote copy pairs are constructed between the primary site 201P and the secondary site 201S. Specifically, for example, two consistency groups 401 (401a, 401b) are constructed between the primary site 201P and the secondary site 201S. The consistency group 401 is configured by the JNLG 402 of one or more remote copy pairs ensuring consistency. The JNLG 402 includes a VOL 403 of one or more PVOLs and one or more PJVOLS. In the consistency group 401, a plurality of PVOLS are copied to the SVOL while maintaining consistency. More specifically, for example, in the consistency group 401, the update differential data up to that time for the plurality of PVOLs 102 is copied to the plurality of SVOLs. In addition, the control (consistency control) of the consistency group 401 is managed by PJVOL. In the PJVOL, the update differential data of one or more PVOLs is stored together with metadata such as the write time. When transferring the PVOL data to the secondary site 201S, the primary site 201P transfers the update differential data up to that time among the update differential data written in the PJVOL to the secondary site 201S. As a result, it is possible to copy data to the SVOL while maintaining the consistency of the update times among the plurality of PVOLS.

For example, according to the consistency group 401a, data is copied to the SVOLs 1 and 2 of the JNGL 1 in the secondary node 210S1 via the PJVOL 1 and the SJVOL 1 while maintaining the consistency of the PVOLs 1 and 2 included in the JNGL 1 in the primary node 210P1.

In addition, according to the consistency group 401b, in a state where the consistency between the PVOL 3 of the JNGL 2 and the PVOL 4 of the JNLG 3 in the primary node 210P2 is maintained, data is copied to the SVOL 3 of the JNLG 2 in the secondary node 210S2 and the SVOL 4 of the JNGL 3 in the secondary node 210S3 via the PJVOL 2 of the JNGL 2 in the primary node 210P2, the PJVOL 3 of the JNGL 3, the SJVOL 2 of the JNLG 2 in the secondary node 210S2, and the SJVOL 3 of JNLG 3 in the secondary node 210S3. The PJVOL and the SJVOL may not necessarily correspond to 1:1, and may correspond to 1:many, many:1, or many:many, for example. The PJVOL may be an area on the memory 212.

In addition, the consistency group 401 may be configured by the JNLG 402 in one node 210 in the site 201, or may be configured by the JNLGs 402 in a plurality of nodes 210 in the site 201.

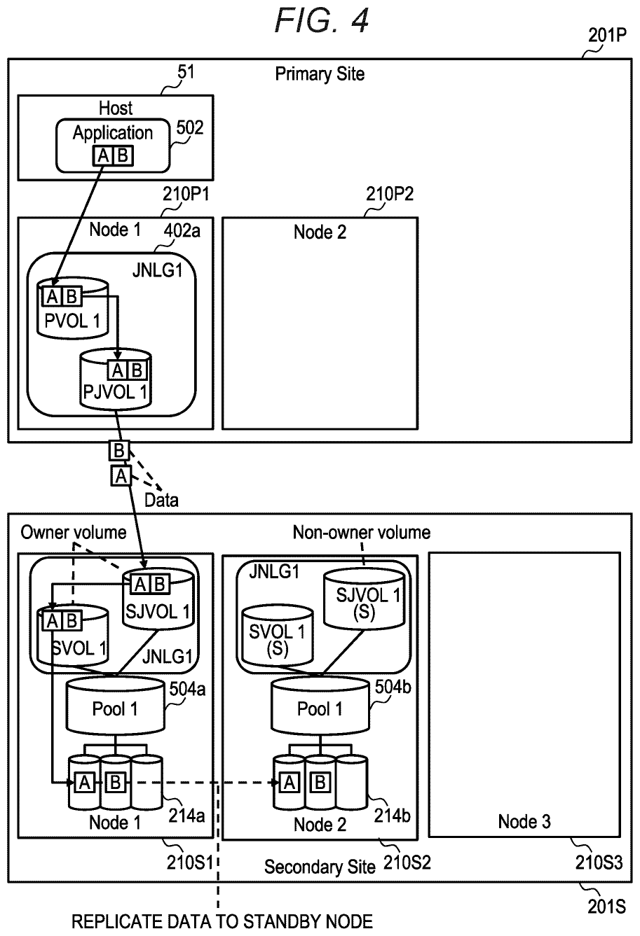

FIG. 4 is a schematic diagram illustrating an outline of a remote copy process according to an embodiment.

First, an application 502 operating on a host 51 issues a write request designating the PVOL 1 to the primary node 210P1. The primary node 210P1 that has received the write request writes the data A and B associated with the write request to the PVOL 1, and further writes the JNL including the data A and B as the update differential data to the PJVOL 1.

Next, the primary node 210P1 transfers the JNL (update differential data) written in the PJVOL 1 to the SJVOL 1 and the SJVOL 1(S) of the secondary site 201S. At this time, in a case where a plurality of paths are established between the primary site 201P and the secondary site 201S, the JNL may be transferred using any path. Normally, the primary node 210P1 transfers the JNL to the secondary node 210S1 having the ownership of the SVOL 1 paired with the PVOL 1. However, when a failure occurs in the path having the ownership, the primary node 210P1 may transfer the JNL to the secondary node 210S2 or the like not having the ownership. For example, when the primary node 210P1 transfers the JNL to the secondary node 210S2 not having the ownership, the secondary node 210S2 transfers the received JNL to the secondary node 210S1 having the ownership, and the secondary node 210S1 writes the JNL to the SJVOL 1.

Next, the secondary node 210S1 writes the data A and B in the JNL written in the SJVOL 1 to the SVOL 1. Then, the data A and B written to the SVOL 1 are written to a drive 214a via a storage pool 504a. In a case where the configuration of the drive 214a is a direct attached storage (DAS) in which the node 210 and the drive 214 are connected on a one-to-one basis, the JNL is written to the drive 214a mounted on the secondary node 210S1. By writing all the data to be copied to the SVOL 1 in the drive 214a of the secondary node 210S1 having the ownership of the SVOL 1 in this manner, it is not necessary to read data from another node when reading data from the SVOL 1 later. As a result, an inter-node transfer process can be eliminated, and a high-speed read process can be realized.

Note that the storage pool 504 may be an area based on one or more drives 214. Storage functions such as thin-provisioning, compression, or deduplication are provided, and processing of the storage functions necessary for the data written to the storage pool 504 is executed.

The secondary node 210S1 also writes redundant data of data to be written to a drive 214b of the secondary node 210S2 in order to protect the data from a node failure when writing the data to the drive 214a. For writing of redundant data, in a case where the data protection policy is replication, a replica of the data is written to the drive 214b as redundant data. On the other hand, in a case where the data protection policy is Erasure Coding, a parity is calculated from the data, and the calculated parity is written to the drive 214b as redundant data.

Although not illustrated, the primary node 210P1 transfers data to be written in the PVOL 1 to the primary node 210P2 (redundancy), and the primary node 210P2 receives the data and writes the data in the PVOL 1(S). In addition, the primary node 210P2 writes the JNL to the PJVOL 1(S). The JNL written to the PJVOL 1(S) may be the JNL transferred from the primary node 210P1, or may be the JNL generated on the basis of the data written to the PVOL 1(S). In this way, the PVOL 1(S) as a copy of the PVOL 1 and the JNLG 1 including the PJVOL 1(S) as a copy of the PJVOL 1 are maintained.

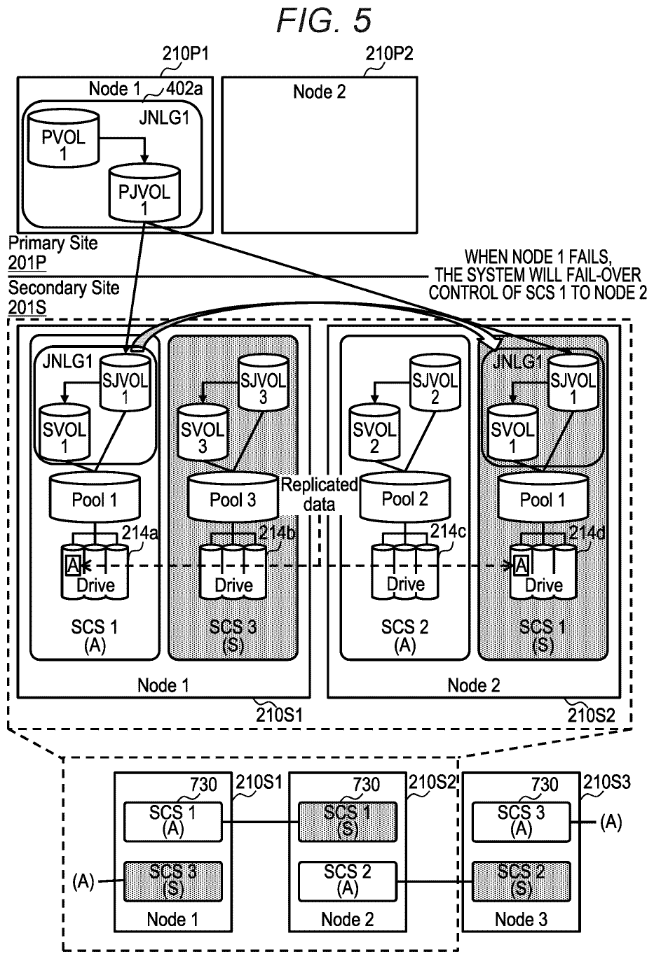

FIG. 5 is a schematic diagram illustrating an outline of a recovery process from a node failure according to an embodiment.

In the secondary nodes 210S1, 210$2, and 210S3, the SCS 730 operates. The secondary node has an SCS (A) and an SCS(S) belonging to the same CSC group as the SCS (A) of another secondary node. For example, the secondary node 210S1 includes an SCS 1(A) and an SCS 3(S), the secondary node 210S2 includes an SCS 2(A) and an SCS 1(S), and the secondary node 210S3 includes an SCS 3(A) and an SCS 2(S). The SCS x(A) and the SCS x(S) belong to the SCS group x, and the number of SCS x(S) is not limited to one and a plurality of SCS x(S) may exist.

The secondary node 210S2 has configuration information of the SVOL 1 and the SJVOL 1 included in the JNLG 1 of the secondary node 210S1 duplicated in order to take over the remote copy pair information of the secondary node 210S1. In addition, the secondary node 210S2 stores redundant data of data written in the drive 214a of the secondary node 210S1 in a drive 214d. Further, the secondary node 210S2 establishes a path (communication path) with the primary node 210P1.

Then, for example, when the secondary node 210S1 stops due to a failure, the secondary node 210S2 that has detected the failure of the secondary node 210S1 takes over the processing of the SCS 1(A) of the secondary node 210S1, and the SCS 1(S) is changed to the SCS 1(A). The secondary node 210S2 communicates with the primary node 210P1 and continues the remote copy process with the JNLG 1. That is, the failover from the SCS 1(A) of the secondary node 210S1 to the SCS 1(S) of the secondary node 210S2 is performed. As a result, even if a node failure occurs in any of the secondary sites 210S, another secondary site 210S can continue remote copy from the primary site 201P.

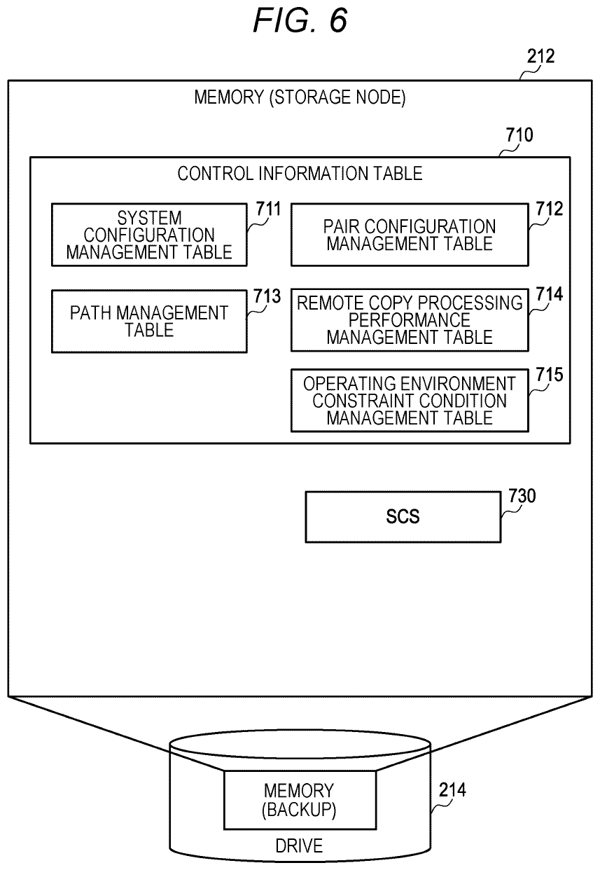

FIG. 6 is a diagram of a configuration of a memory of a storage node according to an embodiment.

The memory 212 stores a control information table 710 and an SCS 730. The control information table 710 includes a system configuration management table 711, a pair configuration management table 712, a path management table 713, a remote copy processing performance management table 714, and an operating environment constraint condition management table 715. For example, the various tables and the SCS 730 included in the control information table 710 may be developed on the memory 212 during execution of processing to be used, and may be stored in the drive 214 in preparation for a power failure or the like at other times.

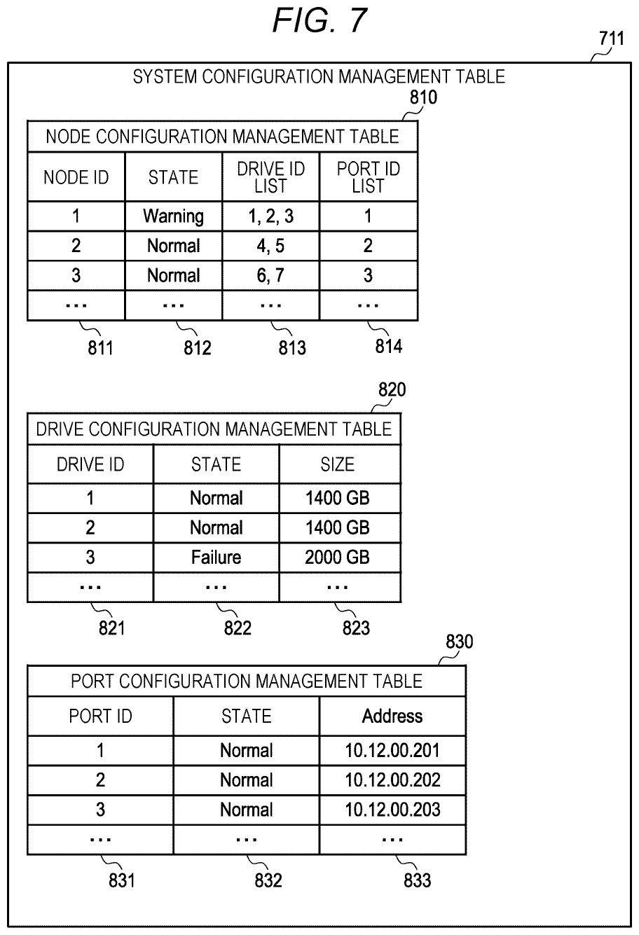

FIG. 7 is a diagram illustrating a configuration of a system configuration management table according to an embodiment.

The system configuration management table 711 includes a node configuration management table 810, a drive configuration management table 820, and a port configuration management table 830. For each site 201, the node configuration management table 810 is provided for a plurality of nodes 210 present in each site 201, and the node 210 includes the drive configuration management table 820 and the port configuration management table 830 for the drive 214 in the node 210.

The node configuration management table 810 is provided for each site 201 and stores information indicating a configuration related to the node 210 provided in the site 201 (a relationship between the node 210 and the drive 214, or the like). The node configuration management table 810 stores an entry corresponding to each node 210. The entry of the node configuration management table 810 includes fields of a node ID 811, a state 812, a drive ID list 813, and a port ID list 814.

The node ID 811 stores an ID (node ID) of the node 210 corresponding to the entry. The state 812 stores information indicating the state of the node 210 corresponding to the entry. Examples of the state of the node 210 include “Normal”, “Warning”, “Failure”, and the like. The drive ID list 813 stores IDs (drive IDs) of one or more drives 214 provided in the node 210 corresponding to the entry. The port ID list 814 stores the ID of the port 215 provided in the node 210 corresponding to the entry.

The drive configuration management table 820 is provided for each node 210 and stores information indicating a configuration related to the drive 214 provided in the node 210. The drive configuration management table 820 stores a corresponding entry for each drive 214. The entry of the drive configuration management table 820 includes fields of a drive ID 821, a state 822, and a size 823.

The drive ID 821 stores the drive ID of the drive 214 corresponding to the entry. The state 822 stores information indicating the state of the drive 214 corresponding to the entry. The size 823 stores the capacity of the drive 214 corresponding to the entry.

The port configuration management table 830 is provided for each node 210 and stores information indicating a configuration related to the port 215 provided in the node 210. The port configuration management table 830 stores an entry corresponding to each port. The entry of the port configuration management table 830 stores fields of a port ID 831, a state 832, and an address 833.

The ID of the port 215 corresponding to the entry is stored in the port ID 831. The state 832 stores information indicating the state of the port 215 corresponding to the entry. The address 833 stores an address on the network assigned to the port 215 corresponding to the entry. The form of the address may be an Internet protocol (IP), a world wide name (WWN), a media access control (MAC) address, or the like.

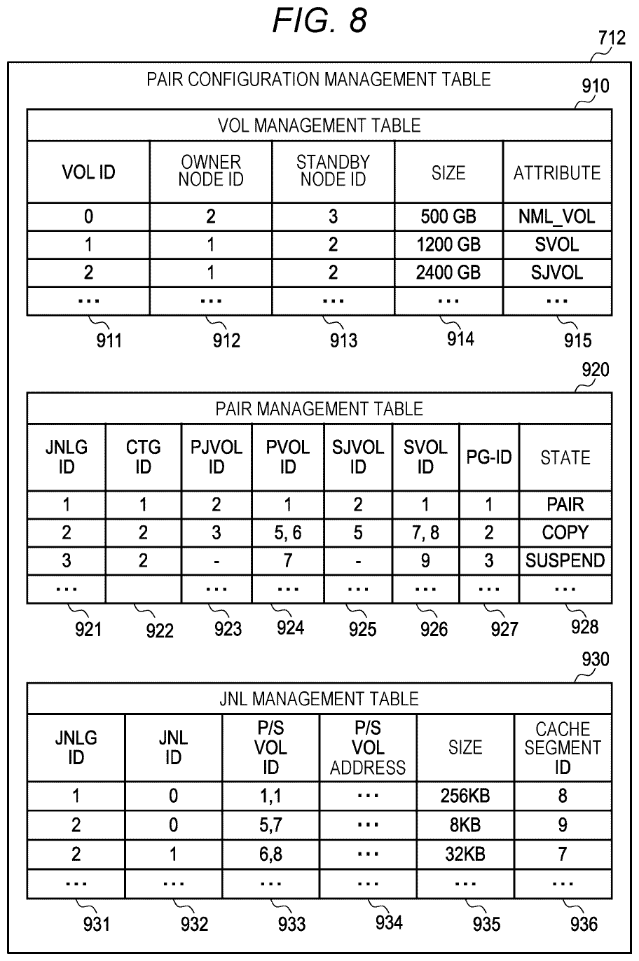

FIG. 8 is a diagram illustrating a configuration of a pair configuration management table according to an embodiment.

The pair configuration management table 712 includes a VOL management table 910, a pair management table 920, and a JNL management table 930.

The VOL management table 910 stores information indicating a configuration related to the VOL 403. The VOL management table 910 stores an entry corresponding to each VOL 403. The entry of the VOL management table 910 includes fields of a VOL ID 911, an owner node ID 912, a standby node ID 913, a size 914, and an attribute 915.

In the VOL ID 911, the ID of the VOL 403 corresponding to the entry is stored. The owner node ID 912 stores an ID of the node 210 (owner node) having the ownership of the VOL 403 corresponding to the entry. In the standby node ID 913, the ID of the node 210 (backup destination node) that takes over processing when the node 210 having the ownership of the VOL (SVOL) corresponding to the entry fails is stored. In the size 914, the capacity of the VOL 403 corresponding to the entry is stored.

The attribute 915 stores an attribute of the VOL 403 corresponding to the entry. Examples of the attributes of the VOL 403 include “NML_VOL” indicating a normal VOL not used for remote copy, “PVOL” meaning a primary VOL, “PJVOL” meaning a JVOL that stores update differential data of PVOL, “SVOL” meaning a secondary VOL, and “SJVOL” meaning a JVOL that stores update differential data of SVOL.

The pair management table 920 stores information indicating a configuration related to a remote copy pair. The pair management table 920 stores an entry corresponding to each JNLG group. The entry of the pair management table 920 includes fields of a JNLG ID 921, a CTG ID 922, a PJVOL ID 923, a PVOL ID 924, a SJVOL ID 925, a SVOL ID 926, a PG-ID 927, and a state 928.

The ID of the JNLG corresponding to the entry is stored in the JNLG ID 921. The CTG ID 922 stores an ID (CTG ID) of a consistency group including the JNLG corresponding to the entry. The PJVOL ID 923 stores IDs of one or more PJVOLs belonging to the JNLG corresponding to the entry. The PVOL ID 924 stores IDs of one or more PVOLS belonging to the JNLG corresponding to the entry. The SJVOL ID 925 stores IDs of one or more SJVOLs belonging to the JNLG corresponding to the entry. The SVOL ID 926 stores IDs of one or more SVOLs belonging to the JNLG corresponding to the entry. The PG-ID 927 stores the ID of the path group used in the remote copy pair belonging to the JNLG corresponding to the entry. In the state 926, the state of the remote copy pair in the JNLG corresponding to the entry is stored. As the state of the copy pair, there are “PAIR” and “COPY” indicating a state in which writing to the PVOL is periodically reflected in the SVOL, “COPY” indicating a state during initial copy, and “SUSPEND” indicating a state in which synchronization between the PVOL and the SVOL is not performed (pair suspended state).

The JNL management table 930 stores information regarding a JNL. The JNL management table 930 stores an entry corresponding to each JNL. The entry of the JNL management table 930 includes fields of a JNLG ID 931, a JNL ID 932, a P/SVOL ID 933, a P/SVOL address 934, a size 935, and a cache segment ID 936.

The JNLG ID 931 stores the ID of the JNLG to which the JNL corresponding to the entry belongs. The JNL ID 932 stores the ID of the JNL corresponding to the entry. The ID of the JNL corresponds to SEQ #, and is, for example, a serial number in the JNLG. That is, the ID of a JNL represents the order of writing, and the data in a JNL is stored in the SVOL in a JNLG in the order of the ID of a JNL.

The P/SVOL ID 933 stores the ID of the PVOL in which the data in the JNL corresponding to the entry is written and the ID of the SVOL in which the data in the JNL is written. In the P/SVOL address 934, a storage destination address of the data in the PVOL in which the data in the JNL corresponding to the entry is written and a storage destination address of the data in the SVOL in which the data in the JNL is written are stored.

The size 935 stores the size of the JNL corresponding to the entry. The cache segment ID 936 stores a cache segment to which the data in the JNL corresponding to the entry is written, that is, an ID of one region in the cache provided in the memory 212.

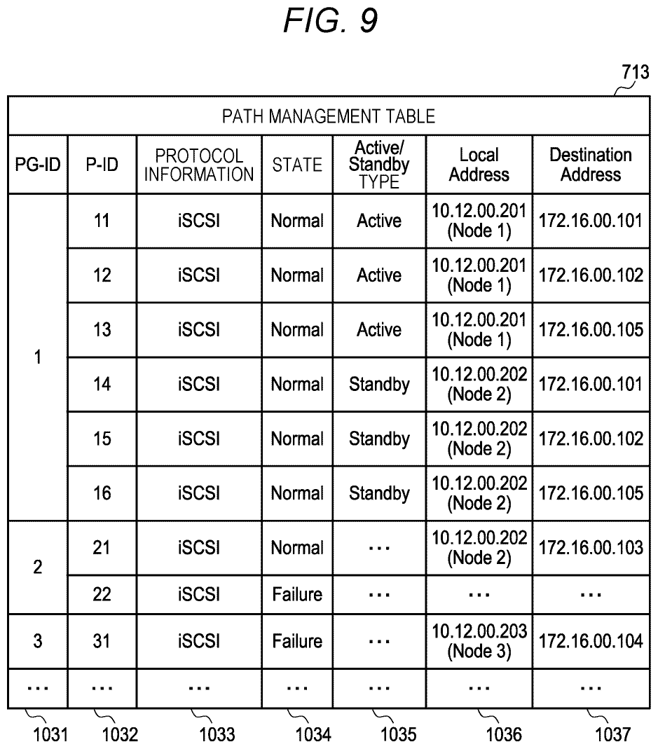

FIG. 9 is a diagram illustrating a configuration of a path management table according to an embodiment. Each value of the path management table of FIG. 9 corresponds to a case where the path illustrated in FIG. 1 is set in the computer system 101.

The path management table 713 stores information regarding a path 60. The path management table 713 stores an entry corresponding to each path 60. Entries of the path management table 713 include fields of a PG-ID 1031, a P-ID 1032, protocol information 1033, a state 1034, an active/standby type 1035, a local address 1036, and a destination address 1037.

The PG-ID 1031 stores an ID of a path group to which the path 60 corresponding to the entry belongs. The P-ID 1032 stores the ID of the path 60 corresponding to the entry. Information indicating the communication protocol of the path 60 corresponding to the entry is stored in the protocol information 1033. The state 1034 stores the state of the path 60 corresponding to the entry. Examples of the path state include “Normal” indicating normal, “Failure” indicating that a failure has occurred, and the like.

In the active/standby type 1035, a type of whether the path corresponding to the entry is an active path or a standby path is stored. In the local address 1036, an address of a port (initiator port) to be an initiator of the path 60 corresponding to the entry is stored. In the present embodiment, the address of the port (target port) to be a target of the path 60 corresponding to the entry is stored in the destination address 1037 in which the port on the secondary storage system 100S side is the initiator port.

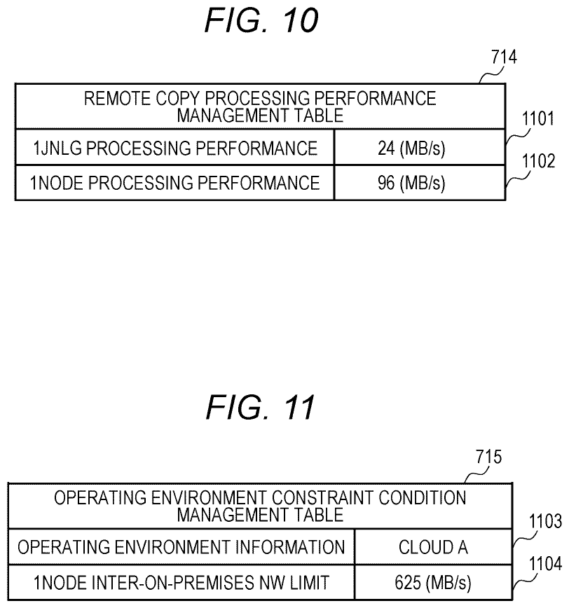

FIG. 10 is a diagram of a configuration of a remote copy processing performance management table according to an embodiment.

The remote copy processing performance management table 714 is provided for each node, and stores information regarding specifications of processing performance regarding the remote copy processing. The remote copy processing performance management table 714 includes fields of a 1JNLG processing performance 1101 and a 1node processing performance 1102.

In the 1JNLG processing performance 1101, a value of processing performance that can be realized in the remote copy process for one JNLG in the node is stored. In the 1node processing performance 1102, a value of processing performance that can be realized in the remote copy processing in the node is stored. In the example of FIG. 10, the processing performance value in the remote copy process for one JNLG is 24 MB/s, and the processing performance value in the remote copy process at the node is 96 MB/s. From this, it can be seen that four JNLGs can be arranged in this node.

FIG. 11 is a diagram of a configuration of the operating environment constraint condition management table according to an embodiment.

The operating environment constraint condition management table 715 is provided for each node and stores information regarding a constraint condition in the operating environment. The operating environment constraint condition management table 715 includes fields of operating environment information 1103 and a 1node inter-on-premises NW limit 1104.

The operating environment information 1103 stores information indicating an environment in which the node is operating. Examples of the environment information include on-premises and clouds. The limit value of the communication amount of the network (NW) with respect to the on-premises in the node is stored in the 1node inter-on-premises NW limit 1104. The operating environment constraint condition management table 715 of FIG. 11 indicates that the communication amount is limited to 625 MB/s per node in a cloud A.

Next, the configuration of the memory 232 of the management node 230 will be described.

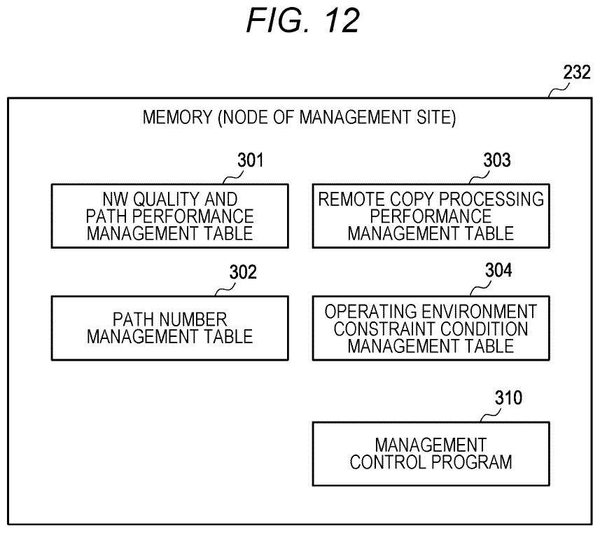

FIG. 12 is a diagram of a configuration of a memory of a management node according to an embodiment.

The memory 232 stores an NW quality and path performance management table 301, a path number management table 302, a remote copy processing performance management table 303, an operating environment constraint condition management table 304, and a management control program 310 as an example of a path setting program.

With respect to the remote copy processing performance management table 303 and the operating environment constraint condition management table 304, the remote copy processing performance management table 714 and the operating environment constraint condition management table 715 are acquired from the nodes 210 of the primary site 201P and the secondary site 201S, and among them, a table with strict constraints can be obtained.

FIG. 13 is a diagram of a configuration of an NW quality and path performance management table according to an embodiment.

The NW quality and path performance management table 301 stores information regarding the quality of the network between the primary site 201P and the secondary site 201S and the performance of the path. The NW quality and path performance management table 301 includes fields of a window size 1301, a round trip time 1302, a single path performance 1303, and a path number upper limit performance 1304.

The window size 1301 stores a window size indicating the amount of data that can be transmitted at a time in communication between the primary site 201P and the secondary site 201S. The round trip time 1302 stores an RTT from transmission of data in communication between the primary site 201P and the secondary site 201S to reception of an acknowledgement. The single path performance 1303 stores a performance value of a transmission amount for one path between the primary site 201P and the secondary site 201S. The path number upper limit performance 1304 stores a performance value (upper limit performance value) indicating an upper limit transmission amount of a plurality of paths belonging to one path group. In the present embodiment, a previous value and a current value are stored in each field. Here, in a case where the network connection protocol is iSCSI, the performance value of one path is calculated by the window size/RTT, and the upper limit performance value is calculated by the performance value of one path×the maximum number of paths in the path group (in the present example, for example, eight).

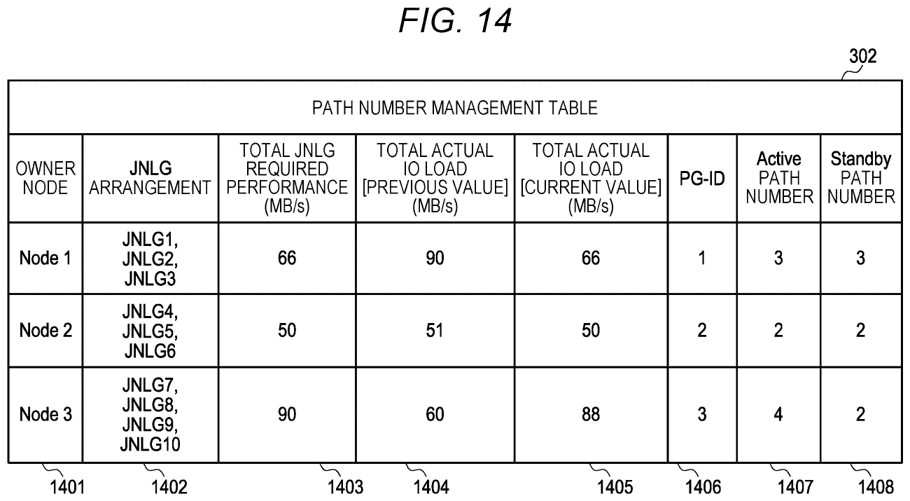

FIG. 14 is a diagram illustrating a configuration of a path number management table according to an embodiment.

The path number management table 302 manages information regarding the number of active paths and the number of standby paths in the path group. The path number management table 302 stores an entry for each path group. One path group may be allocated to each node, or a plurality of path groups may be allocated to one node. The entries of the path number management table 302 include fields of an owner node 1401, a JNLG arrangement 1402, a total JNLG required performance 1403, a total actual IO load [previous value] 1404, a total actual IO load [current value] 1405, a PG-ID 1406, an active path number 1407, and a standby path number 1408. The entry may include a field for storing the address (local address) of the initiator port of the path belonging to the path group corresponding to the entry and the address (destination address) of the target port.

The owner node 1401 stores identification information (for example, a node name) of a node to be an owner of a JNLG that uses the path group corresponding to the entry. In the JNLG arrangement 1402, identification information (for example, a JNLG name) of one or more JNLGs using the path group for the entry is stored. In the total JNLG required performance 1403, a total value (required performance total) of the performance required for the JNLG remote copy using the path group corresponding to the entry is stored. In the total actual IO load [previous value] 1404, a total value of previous actual IO loads by the JNLG using the path group corresponding to the entry is stored. In the total actual IO load [current value] 1405, a total value of current actual IO loads by the JNLG using the path group corresponding to the entry is stored. The total value of the actual IO loads can be obtained, for example, from the node 210 at the primary site 201P. The ID of the path group corresponding to the entry is stored in the PG-ID 1406. The number of paths (active paths) set in the node including the active SCS 730 that performs the JNLG remote copy process using the path group corresponding to the entry is stored in the active path number 1407. The Standby path number 1408 stores the number of paths (standby paths) set in the node including the standby SCS 730 that performs the JNLG remote copy process using the path group corresponding to the entry.

Next, a processing operation in the computer system 101 will be described.

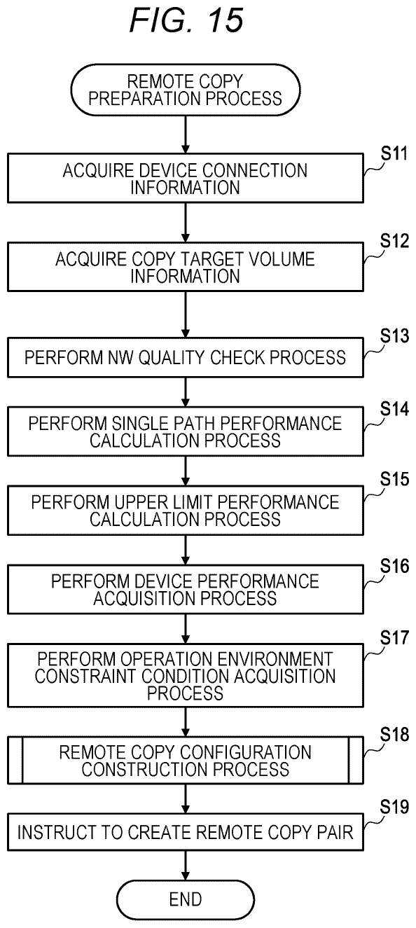

FIG. 15 is a flowchart of a remote copy preparation process according to an embodiment. Note that it is assumed that the nodes 210 of the primary site 201P and the secondary site 201S have been activated before the execution of the remote copy preparation process.

The management control program 310 (strictly speaking, the processor 231 that executes the management control program 310) of the management node 230 acquires connection information (for example, an IP address or the like) for connecting the nodes 210 of the primary site 201P and the secondary site 201S (S11). Here, the connection information may be acquired by being interactively input from the user (administrator), or may be acquired by reading a text created in advance by the user.

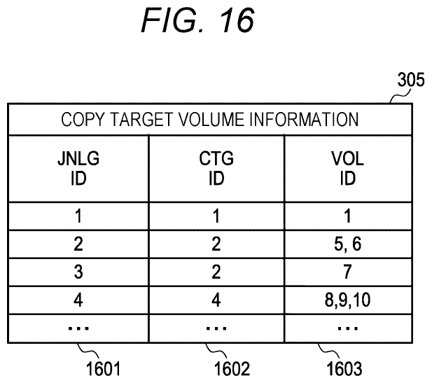

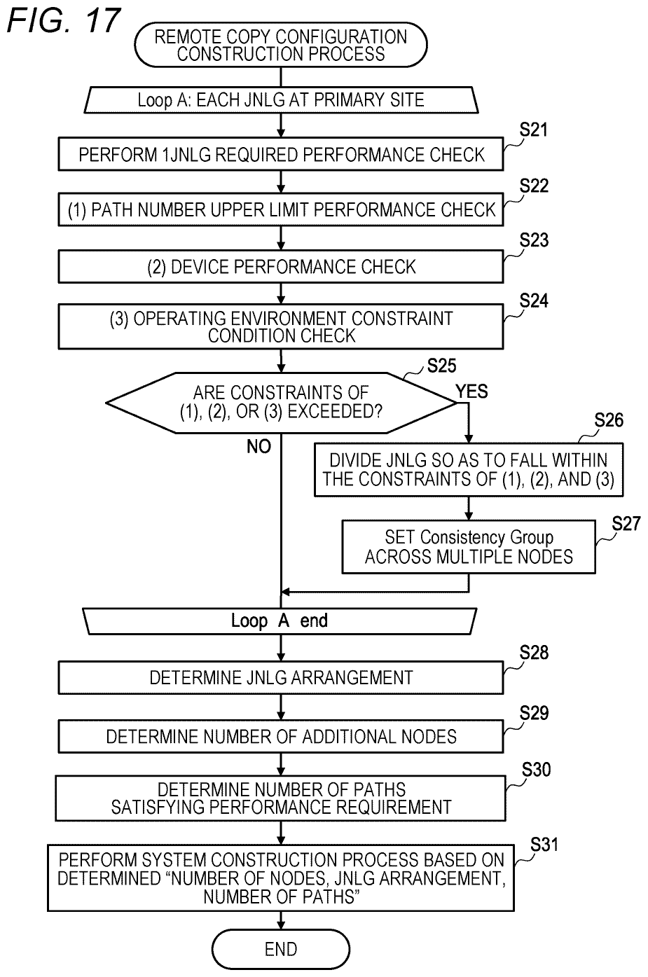

Next, the management control program 310 acquires information (copy target volume information, see FIG. 16) of the volume to be copied from the user (S12). Here, the copy target volume information may be acquired by an interactive input from the user, or may be acquired by reading a text created in advance by the user.

FIG. 16 is a diagram of a configuration of copy target volume information according to an embodiment.

Copy target volume information 305 includes an entry for each JNLG. The entry of the copy target volume information 305 includes fields of a JNLG ID 1601, a CTG ID 1602, and a VOL ID 1603. The ID of the JNLG corresponding to the entry is stored in the JNLG ID 1601. The ID of the CTG to which the JNLG corresponding to the entry belongs is stored in the CTG ID 1602. The ID of the VOL belonging to the JNLG is stored in the VOL ID 1603.

For example, the second entry of the copy target volume information 305 means that the JNLG with the JNLG ID of 2 belongs to the CTG with the CTG ID of 2, and the VOLs with the VOL IDs of 5 and 6 belong to the JNLG. In this case, the VOLs with the VOL IDs 5 and 6 are copied to the secondary site in a state where consistency is maintained so that the write order is guaranteed.

Returning to the description of FIG. 15, the management control program 310 performs a quality check process of the network (S13). Specifically, the management control program 310 acquires the window size and the RTT in the communication between the primary storage system 100P and the secondary storage system 100S, stores the current value as the previous value in the window size 1301 and the round trip time 1302 of the NW quality and path performance management table 301, and stores the acquired window size and RTT as the current value.

Next, the management control program 310 performs a single path performance calculation process of calculating performance values of one path (S14). Specifically, the management control program 310 calculates the performance value of one path by dividing the window size by the RTT, stores the current value to the previous value in the single path performance 1303 of the NW quality and path performance management table 301, and stores the calculated performance value to the current value.

Next, the management control program 310 performs an upper limit performance calculation process of calculating a performance value (upper limit performance value) when all paths in the path group are used (S15). Specifically, the management control program 310 calculates the upper limit performance value by multiplying the performance value of one path by the maximum number of paths of the path group, stores the current value as the previous value in the path number upper limit performance 1304 of the NW quality and path performance management table 301, and stores the calculated upper limit performance value as the current value.

Next, the management control program 310 performs a device performance acquisition process (S16).

Specifically, the management control program 310 acquires information of the remote copy processing performance management table 714 from each node 210 of the primary site 201P and the secondary site 201S, and stores information of a node having the lowest performance among the acquired information of the remote copy processing performance management table 714 in the remote copy processing performance management table 303. For example, in the present embodiment, since the performance of the node of the secondary site 201S is low, the information of the node of the secondary site 201S is stored in the remote copy processing performance management table 303.

Next, the management control program 310 performs an operation environment constraint condition acquisition process (S17). Specifically, the management control program 310 acquires information of the operating environment constraint condition management table 715 from each node 210 of the primary site 201P and the secondary site 201S, and stores information with the strictest constraint among the acquired information of the remote copy processing performance management table 714 in the operating environment constraint condition management table 304. For example, in the present embodiment, since there is a constraint on the secondary site 201S side and there is no constraint on the primary site 201P side, the information of the secondary site 201S is stored in the operating environment constraint condition management table 304.

Next, the management control program 310 executes a remote copy configuration construction process (see FIG. 17) for setting a configuration (VOL or path) of remote copy (S18).

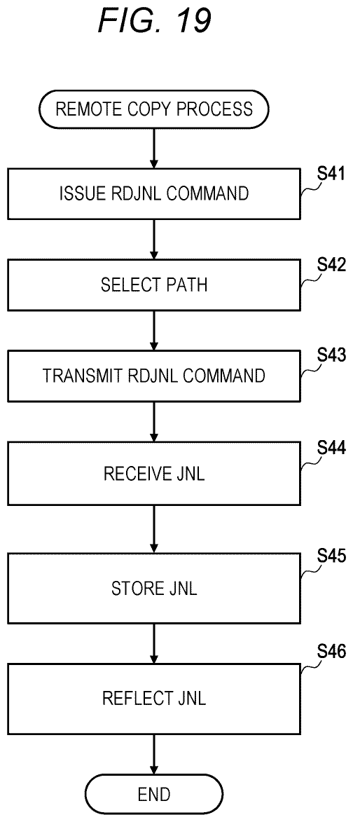

Next, the management control program 310 instructs the primary storage system 100P of the primary site 201P to create a remote copy pair (S19), and ends the process. As a result, communication is performed between the primary storage system at the primary site and the secondary storage system at the secondary site, and the remote copy process (see FIG. 19) is started.

Next, the remote copy configuration construction process in step S18 will be described in detail.

FIG. 17 is a flowchart of a remote copy configuration construction process according to an embodiment.

The management control program 310 executes the process of the loop A (S21 to S27) on each JNLG of the primary site 201P. Here, the JNLG to be processed is referred to as target JNLG.

In the process of the loop A, the management control program 310 performs 1JNLG required performance check to check the performance required by the target JNLG (S21). Specifically, the management control program 310 checks the performance value (1JNLG required performance value) required by the target JNLG from the IO statistics managed by the node of the primary site 201P or from the input by the user.

Next, the management control program 310 performs (1) path number upper limit performance check to check whether the 1JNLG required performance value falls within the path number upper limit performance value that is the upper limit performance of the path group (S22).

Next, the management control program 310 performs (2) a device performance check process of checking whether the 1JNLG required performance value falls within a 1JNL processing performance value in the nodes of the copy source and the copy destination (S23). Here, in a case where the 1JNLG required performance value does not fall within the 1JNL processing performance value, an error in which the JNL of the JVOL overflows occurs. Therefore, in (2) the device performance check process, it is checked whether such a situation occurs.

Next, the management control program 310 performs (3) an operating environment constraint condition check process of checking whether the constraint conditions in the operation environment are satisfied (S24).

Next, the management control program 310 determines whether any constraint in each check process of (1), (2), or (3) is exceeded (S25). As a result, in a case where the constraints in all the check processes of (1), (2), and (3) are not exceeded (S25: NO), the management control program 310 changes the JNLG to be processed to the next JNLG and executes the process of the loop A.

On the other hand, in a case where the constraint in the check process of any one of (1), (2), or (3) is exceeded (S25: YES), the management control program 310 divides the JNLG so that the JNLG falls within the constraints of all the check processes of (1), (2), and (3) (S26), sets the plurality of divided JNLGs to one CTG (S27), changes the JNLG to be processed to the next JNLG, and executes the process of the loop A. Step S27 may not be performed.

In a case where the process of the loop A is executed with all the JNLGs as processing targets, the management control program 310 exits the loop A and performs a JNLG arrangement determination process of determining the arrangement of the JNLG (S28). In the JNLG arrangement determination process, the management control program 310 refers to the information of the table, and determines the node in which the JNLG is arranged so that the sum of the required performance values of the JNLG arranged in each node falls within a range not exceeding 1node processing performance.

Next, in a case where the JNLG cannot be arranged with the number of existing nodes in step S28, the management control program 310 determines the number of nodes to be expanded, and instructs the user to expand the nodes, for example (S29).

Next, the management control program 310 refers to the NW quality and path performance management table 301, determines the number of paths satisfying the performance requirement, and stores the determined content in the path number management table 302 (S30).

Specifically, for example, in a case where one path group is allocated to one node, the management control program 310 calculates the minimum necessary number of paths (integer value: necessary number) for the paths for the active SCS by dividing the total performance requirement value of the JNLG arranged in one node by one path performance value. In this case, the number of paths for the active SCS to be actually constructed may be equal to or larger than the calculated number of paths. For example, when the calculated number of paths is used, the number of paths to be used can be reduced, or more paths can be set for the standby SCS.

In addition, the management control program 310 determines the number of paths for the standby SCS belonging to the same SCS group as the active SCS as one of the following.

For example, in a case where the same number of paths as the active SCS can be set within the maximum number of path groups, the number of paths for the standby SCS is determined to be the same as the number of paths for the active SCS. In this way, the same performance as before the failover can be realized at an early stage without setting a path after the failover.

In addition, in a case where the same number of paths as the active SCS cannot be set within the maximum number of path groups, the number of paths for the standby SCS is determined to be the remaining number that can be set in the path group. In this case, after the failover, the number of paths may be set to the same number of paths as the initial active SCS. In this way, since a path is set in the standby SCS in advance, that is, a communicable state is secured, the path can be quickly used after the failover.

In addition, the number of paths for the standby SCS may be one. In this way, since a path is set in the standby SCS in advance, that is, a communicable state is secured, the path can be quickly used after the failover, the number of paths in the nodes at the connection source and the connection destination of the path can be reduced, and in a case where the number of paths that can be set in the port or the node is limited, the allowable amount of path setting to other paths can be increased.

In addition, the number of paths for the standby SCS may be set to zero. In this case, the number of paths in the nodes at the connection source and the connection destination of the path can be reduced, and in a case where the number of paths that can be set in the port or the node is limited, the allowable amount of path setting to other paths can be increased.

In addition, in a case where the total performance requirement value of the plurality of JNLGs of one node exceeds the upper limit performance value of one path group, a plurality of path groups may be allocated to one node, and the path groups to be used may be divided by the JNLG. As a result, in a case where it is not possible to cope with one path group, it is possible to set the path so as to meet the performance requirements of the JNLG by increasing the path groups.

Next, the management control program 310 executes a system construction process of constructing a system on the basis of the determined number of nodes, the JNLG arrangement, and the number of paths (S31), and ends the remote copy configuration construction process. In the system construction process, construction in the primary storage system 100P and the secondary storage system 100S is performed under the control of the management control program 310, and information corresponding to the constructed situation is registered in the system configuration management table 711, the pair configuration management table 712, and the path management table 713. Here, the connection destinations of the paths in the primary storage system 100P may be distributed to a plurality of ports of a plurality of nodes. In the system construction process, the management control program 310 creates not only the PVOL and the PJVOL of the primary site 201P but also the SVOL and the SJVOL of the secondary site 201S.

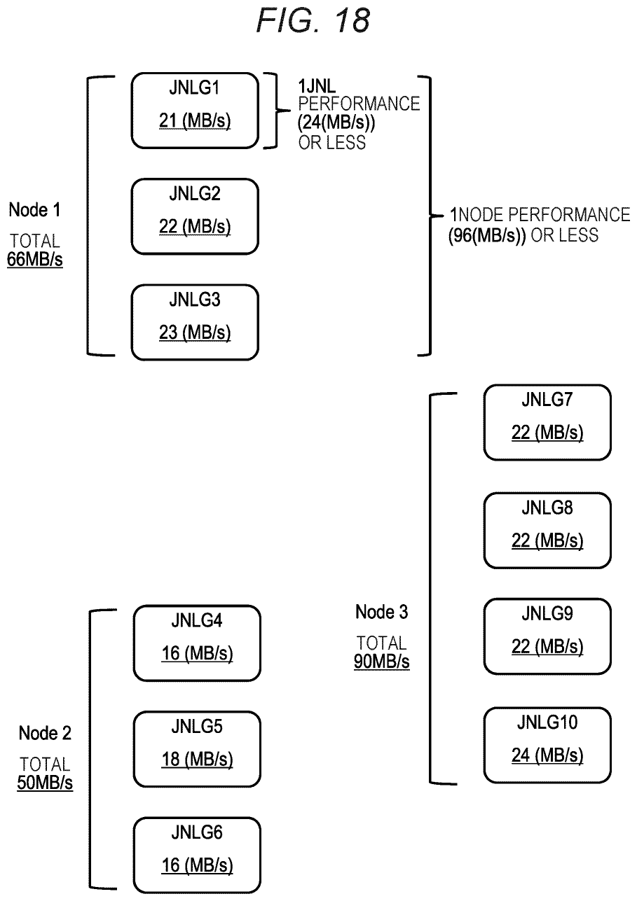

FIG. 18 is a diagram illustrating a JNLG arrangement design example according to an embodiment. The JNLG arrangement design example in FIG. 18 corresponds to the setting content of the path number management table 302 in FIG. 14.

In the example of FIG. 18, the JNLG 1, the JNLG 2, and the JNLG 3 are arranged in Node 1. The required performances of the JNLG 1, the JNLG 2, and the JNLG 3 are 21 MB/s, 22 MB/s, and 23 MB/s, respectively, and the total required performance thereof is 66 MB/s. Here, the required performance of each JNLG is 24 MB/s or less, which is 1JNLG processing performance, and the total required performance is 96 MB/s or less, which is 1node processing performance, and the processes for these JNLGs are arranged so as to be appropriately executed.

In Node 2, the JNLG 4, the JNLG 5, and the JNLG 6 are arranged. The required performance of the JNLG 4, the JNLG 5, and the JNLG 6 is 16 MB/s, 18 MB/s, and 16 MB/s, respectively, and the total required performance thereof is 50 MB/s. Here, the required performance of each JNLG is 24 MB/s or less, which is 1JNLG processing performance, and the total required performance is 96 MB/s or less, which is 1node processing performance, and the processes for these JNLGs are arranged so as to be appropriately executed.

In Node 3, the JNLG 7, the JNLG 8, the JNLG 9, and the JNLG 10 are arranged. The required performance of the JNLG 7, the JNLG 8, the JNLG 9, and the JNLG 10 is 22 MB/s, 22 MB/s, 22 MB/s, and 24 MB/s, respectively, and the total required performance thereof is 90 MB/s. Here, the required performance of each JNLG is 24 MB/s or less, which is 1JNLG processing performance, and the total required performance is 96 MB/s or less, which is 1node processing performance, and the processes for these JNLGs are arranged so as to be appropriately executed.

Next, the remote copy process will be described.

FIG. 19 is a flowchart of a remote copy process according to an embodiment. The remote copy process is repeatedly executed, for example, with a remote copy pair create instruction in step S19 of FIG. 15 as a trigger.

The SCS 1(A) issues an RDJNL command (S41). Next, the SCS 1(A) selects a path to be used (S42). Here, the SCS 1(A) is selected and used from the path set for the active SCS. Here, in a case where a plurality of paths are set, for example, a path to be transmitted by round robin is selected. In the present embodiment, since the number of paths satisfying the required performance of the JNLG is set, remote copy is appropriately performed.

Next, the SCS 1(A) transmits the RDJNL command to the primary storage system 100P using the selected path 60 (S43). The SCS 1(A) receives a JNL transmitted from the primary storage system 100P via the path 60 in response to the RDJNL command (S44). The SCS 1(A) stores the received JNL in the SJVOL 1 (S45).

The SCS 1(A) reflects the non-reflected JNL in the SJVOL 1 in the SVOL 1 in the order of SEQ #(S46). As a result, data in the non-reflected JNL is stored in the SVOL 1.

Note that, although details are omitted, in the remote copy process, the state of the pair group including the remote copy pair and values in various tables are updated as appropriate.

Next, a failover process in which a failure occurs in the active SCS to cause a failover to the standby SCS will be described.

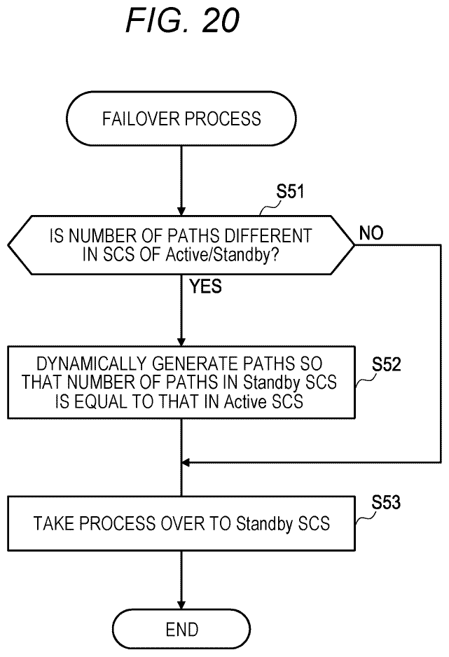

FIG. 20 is a flowchart of a failover process according to an embodiment. The failover process is performed in a case where the standby SCS detects that a failure has occurred in the active SCS. Although described as a process of the standby SCS, the management node may execute at least a part of the process.

The standby SCS determines whether the number of paths for the active SCS is different from the number of paths for the standby SCS (S51).

As a result, in a case where the number of paths for the active SCS and the number of paths for the standby SCS are the same (S51: NO), it means that the failover can be performed without setting a path, and thus, the standby SCS advances the process to step S53.

On the other hand, in a case where the number of paths for the active SCS and the number of paths for the standby SCS are not the same (S51: YES), the standby SCS dynamically generates paths such that the number of paths for the standby SCS becomes the number of paths for the active SCS before the occurrence of a failure (S52), and the process proceeds to step S53.

In step S53, the standby SCS performs a process of taking over the process of the active SCS to the standby SCS, and ends the failover process.

Next, the path number update process will be described.

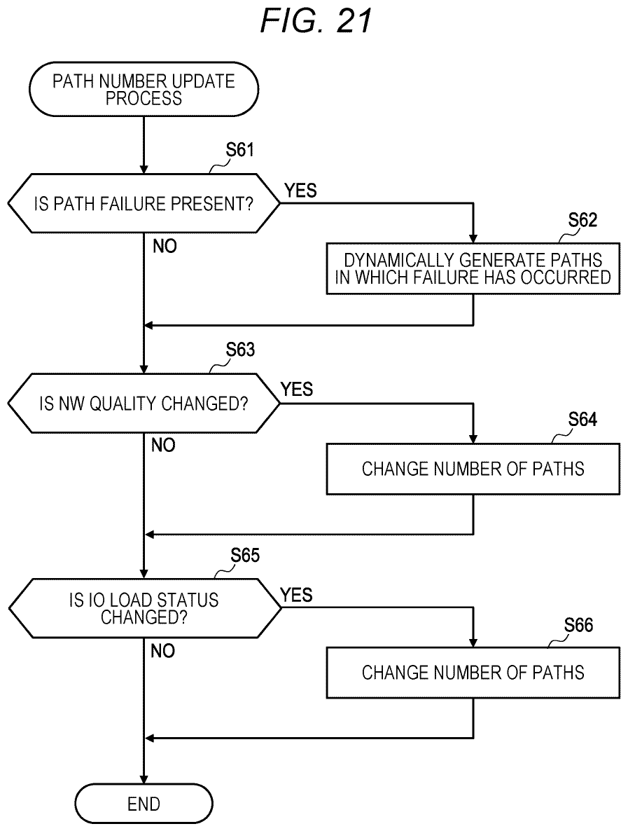

FIG. 21 is a flowchart of a path number update process according to an embodiment. The path number update process is periodically executed, for example.

The management control program 310 acquires path information from the secondary site 201S and determines whether there is a failure in any path (S61). As a result, in a case where there is no failure in any path (S61: NO), the management control program 310 advances the process to step S63.

On the other hand, in a case where there is a failure in any of the paths (S61: YES), the management control program 310 dynamically generates a new path corresponding to the occurrence of a failure (S62), and advances the process to step S63.

In step S63, the management control program 310 acquires information regarding the NW quality from the secondary site 201S, and determines whether there is a change in the NW quality. As a result, in a case where there is no change in the NW quality (S63: NO), the management control program 310 advances the process to step S65.

On the other hand, in a case where there is a change in the NW quality (S63: YES), the management control program 310 performs a process of changing the path line to be suitable for the new NW quality, and advances the process to step S65. Note that the process of changing the number of paths is similar to the process in step S30 in FIG. 17.

In step S65, the management control program 310 acquires information of the IO load of the JNLG from the primary site 201P, and determines whether there is a change in the IO load status. As a result, in a case where there is no change in the IO load (S65: NO), the management control program 310 ends the process.

On the other hand, in a case where there is a change in the IO load status (S65: YES), a process of changing the path main line to be suitable for the current IO load is performed, and the process ends. Note that the process of changing the number of paths may be calculated using the current IO load instead of the performance requirement in the process of step S30 of FIG. 17.

According to the above path number update process, in a case where a failure occurs in a path, in a case where there is a change in the NW quality, and in a case where there is a change in the IO load status, the number of paths can be updated to an appropriate number according to each status.

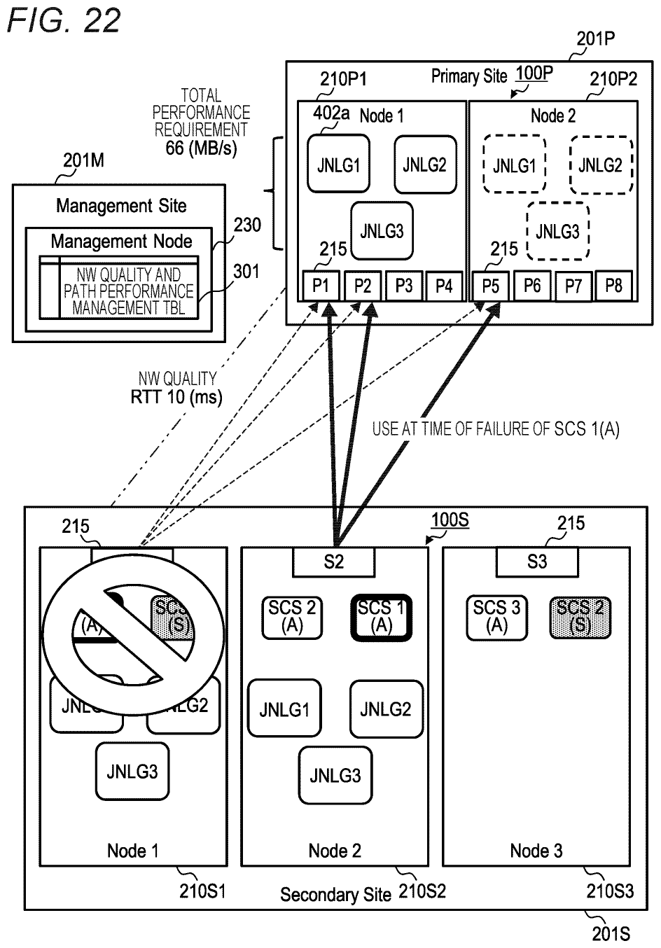

FIG. 22 is a schematic diagram illustrating a state after failover according to an embodiment. FIG. 22 illustrates a state in which, after a path is set as illustrated in FIG. 1, a failure occurs in Node 1, and an SCS 1(S) of Node 2 is changed to an SCS 1(A) due to a failover.

As illustrated in FIG. 1, in Node 2 in which the SCS 1(S) is stored, the same number (three) of paths as the SCS 1(A) are set as paths for the SCS 1(S). Therefore, by the failover process, the state illustrated in FIG. 22 is obtained without newly setting a path, and the SCS 1(S) of Node 2 can be processed as the SCS 1(A) at an early stage.

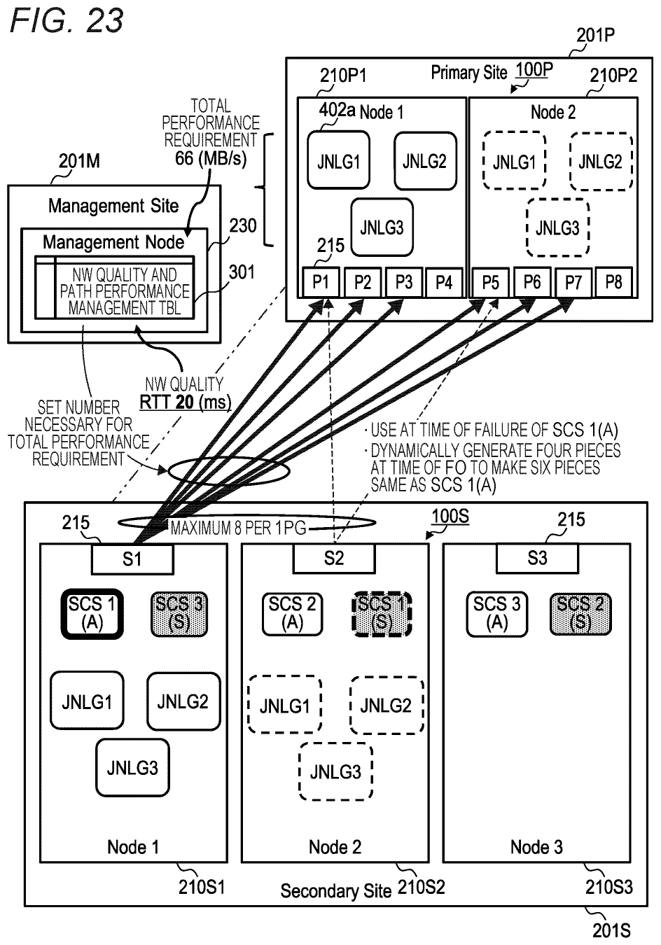

FIG. 23 is a schematic diagram illustrating an outline of dynamic addition of a standby path according to an embodiment.

Here, in the state illustrated in FIG. 23, it is assumed that the RTT indicating the NW quality is 20 ms and the total performance requirement of the JNLG is 66 MB/s.

In this case, the number of paths to be set in the active SCS is calculated to be six, and six paths are set as paths for the SCS 1(A) in Node 1 that stores the SCS 1(A). Here, assuming that the maximum number in one path group is eight, it is not possible to set the same number of paths as the SCS 1(A) in Node 2 that stores the SCS 1(S). Therefore, in Node 2, two paths, which are the maximum number of remaining paths that can be set in the path group, are set.

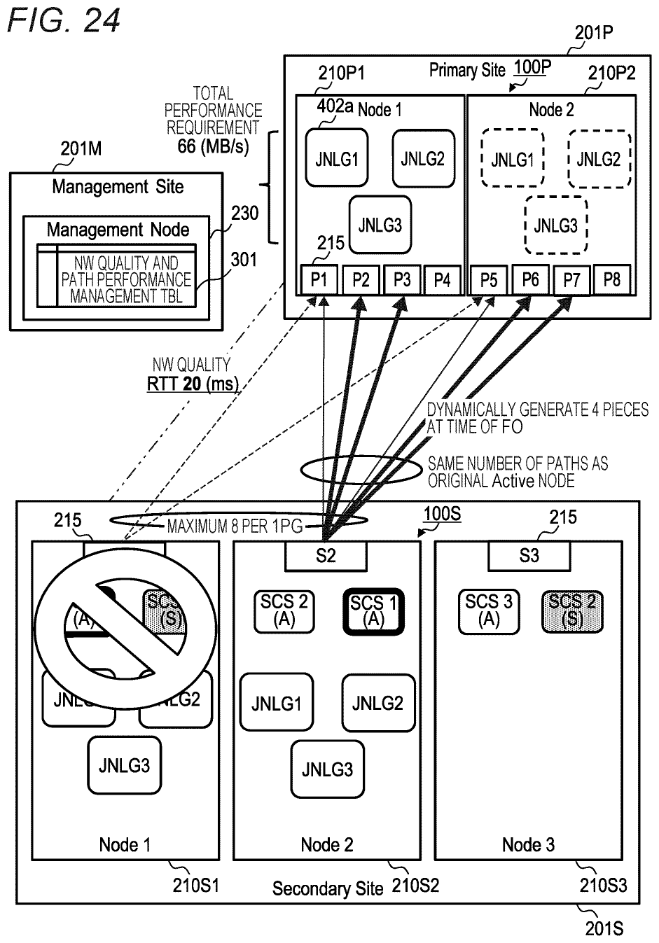

FIG. 24 is a schematic diagram illustrating a state after dynamic addition of a standby path according to an embodiment.

FIG. 24 is a schematic diagram illustrating a state after dynamic addition of a standby path according to an embodiment. FIG. 24 illustrates a state in which, after a path is set as illustrated in FIG. 23, a failure occurs in Node 1, and an SCS 1(S) of Node 2 is changed to an SCS 1(A) due to a failover.

In the state illustrated in FIG. 23, when a failure occurs in Node 1, a failover process of failing over to the SCS 1(S) is performed. In the failover process, four paths are dynamically generated so that the number of paths becomes six, which is the same as the number of paths of the original SCS 1(A). In this case, four paths of Node 1 storing the SCS 1(A) are deleted.

As described above, in a case where the same number of paths as the number of paths of the SCS 1(A) cannot be set for the node initially storing the SCS 1(S) by the failover process, the same number of paths can be set by the failover process, and the process can be executed with the same processing performance as the SCS 1(A).

Next, a path number update process when the NW quality changes will be described.

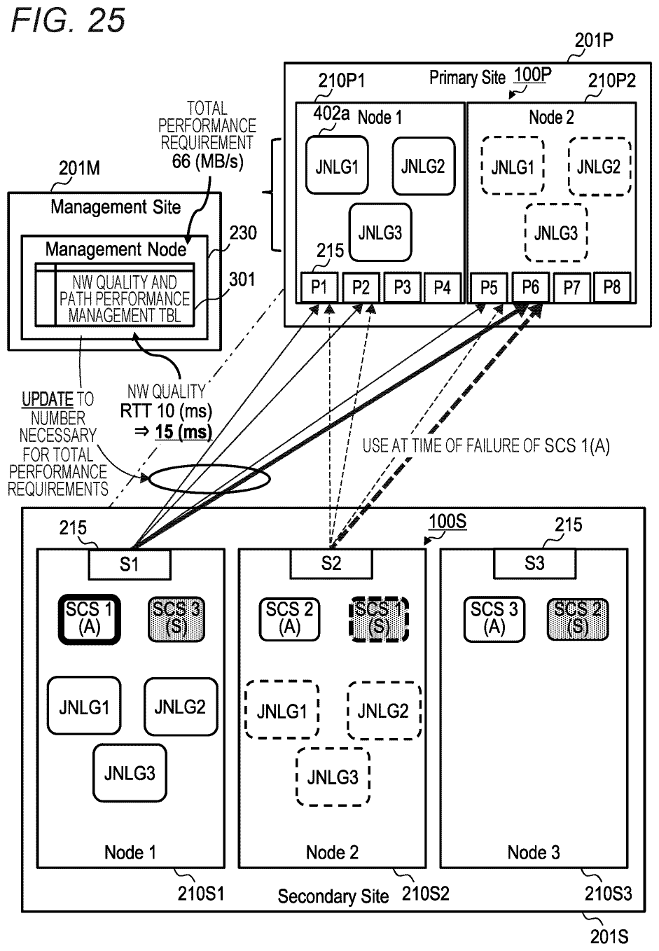

FIG. 25 is a schematic diagram illustrating an outline of a path number update process at the time of an NW quality change according to an embodiment. FIG. 25 illustrates a state in which the NW quality changes and the number of paths is updated after the path is set as illustrated in FIG. 1.

Here, FIG. 25 illustrates an example in which the RTT indicating the NW quality deteriorates to 15 ms.

In a case where the RTT deteriorates to 15 ms, it is detected in step S63 of FIG. 21 that there is a change in the NW quality, and the number of paths is determined in step S64. In this example, since the RTT is 15 ms, the number of paths necessary at that time (the latest necessary number) is determined to be 4. Based on this, in Node 1 storing the SCS 1(A), one insufficient path is added, and one path is also added to Node 2 storing the SCS 1(S). As a result, the number of paths that can be used by the SCS 1(A) can be increased, and the number of paths can be updated to the number suitable for the changed NW quality.

Next, a path number update process when the IO load changes will be described.

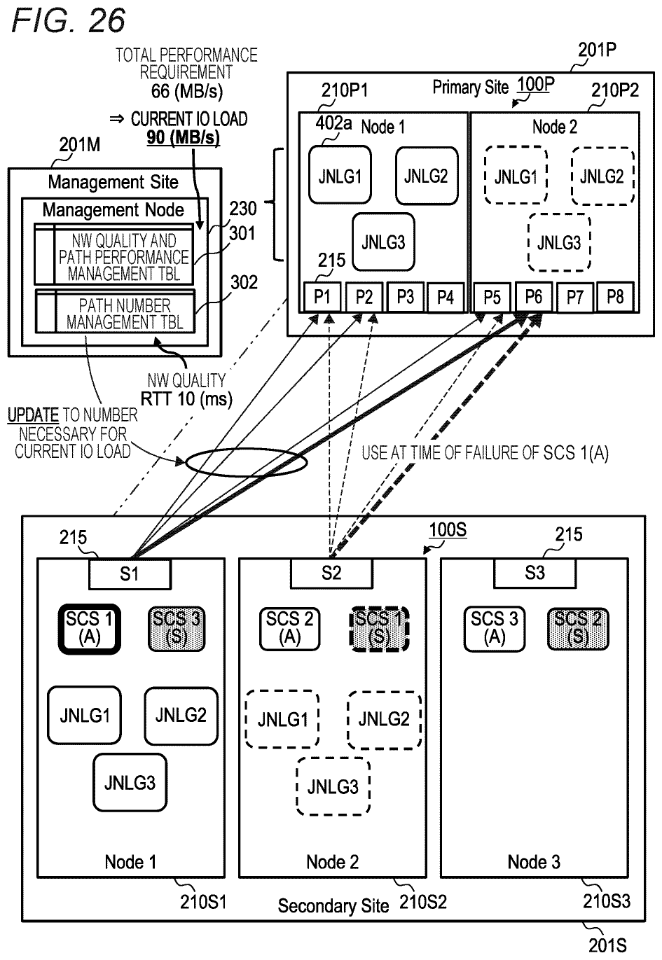

FIG. 26 is a schematic diagram illustrating an outline of a path number update process according to an actual IO load according to an embodiment. FIG. 26 illustrates a state in which the IO load changes and the number of paths is updated after the path is set as illustrated in FIG. 1.

Here, FIG. 26 illustrates an example in which the IO load increases to 90 MB/s.

In a case where the IO load increases to 90 MB/s, it is detected in step S65 of FIG. 21 that there is a change in the IO load, and the number of paths is determined in step S66. In this example, since the IO load is 90 MB/s, the number of necessary paths (the load considered number) is determined to be 4. Based on this, in Node 1 storing the SCS 1(A), one insufficient path is added, and one path is also added to Node 2 storing the SCS 1(S). As a result, the number of paths that can be used by the SCS 1(A) can be increased, and the number of paths can be updated to the number suitable for the changed IO load.

Further, the invention is not limited to the above-described embodiments, and can be implemented in various forms within a scope not departing from the spirit of the invention.

What is claimed is:

1. A management apparatus that manages a path between a first storage system and a second storage system in a computer system including the first storage system and the second storage system that is a copy destination of a predetermined unit of copy of the first storage system, the second storage system including a first node having a first controller that processes copying in the unit of copy and a second node having a second controller that performs a copy process in place of the first controller when a failure occurs in the first controller,
the management apparatus comprising a processor,
wherein the processor is configured to execute:
calculating a necessary number, which is a number of paths necessary for a performance requirement, based on quality of a network between the first storage system and the second storage system and a performance requirement related to a communication amount necessary for copying in the unit of copy; and
setting the necessary number or more of paths between the first storage system and the first node.

2. The management apparatus according to claim 1, wherein the processor is configured to execute setting the necessary number of paths between the first storage system and the first node.

3. The management apparatus according to claim 1, wherein
a maximum number of paths in a path group that is recognized as a same path is limited, and
the processor is configured to execute setting one or more paths between the first storage system and the second node in a case where the number of paths set between the first storage system and the first node is less than the maximum number.

4. The management apparatus according to claim 3, wherein the processor is configured to execute setting the necessary number of paths between the first storage system and the second node in a case where there is a margin of equal to or larger than a necessary number up to the maximum number.

5. The management apparatus according to claim 4, wherein the processor is configured to execute, in a case where there is no margin of equal to or larger than a necessary number up to the maximum number, after a failure occurs in the first controller, and then a process of the first controller is failed over to the second controller, adding a path so that a number of paths between the first storage system and the second node becomes the necessary number.

6. The management apparatus according to claim 1, wherein
the processor is configured to execute:
sequentially checking a quality of a network between the first storage system and the second storage system, and calculating a latest necessary number which is a number of paths necessary for a performance requirement at that time based on the checked quality of the network and a performance requirement related to a communication amount necessary for copying in the unit of copy; and
adjusting a number of paths between the first storage system and the first node to be equal to or larger than the latest necessary number.

7. The management apparatus according to claim 1, wherein the processor is configured to execute checking a status of a path between the first storage system and the first node, and setting another path between the first storage system and the first node in a case where a failure occurs in the path.

8. The management apparatus according to claim 1, wherein
the processor is configured to execute:
checking an actual IO load from the first storage system to the first controller, and calculating a load considered number which is a number of paths that can cope with the IO load based on the IO load; and
adjusting a number of paths between the first storage system and the first controller to be equal to or larger than a load considered number.

9. The management apparatus according to claim 1, wherein
a maximum number of paths in a path group that is recognized as a same path is limited, and
the processor is configured to execute dividing the unit of copy into a plurality of units of copy so as to solve at least one of a case where the necessary number exceeds the maximum number, a case where a node of the first storage system or a node of the second storage system does not satisfy processing performance necessary for copying in the unit of copy, and a case where a constraint condition for communication in a network by a node of the second storage system is not satisfied.

10. The management apparatus according to claim 9, wherein the processor is configured to execute setting the plurality of divided units of copy to one consistency group.

11. The management apparatus according to claim 1, wherein
a maximum number of paths in a path group that is recognized as a same path is limited, and
the processor is configured to execute, in a case where a performance requirement related to a communication amount necessary for copying in a plurality of units of copy arranged in one node of the first storage system exceeds performance by a maximum number of paths in one path group, allocating different path groups to the plurality of units of copy.

12. The management apparatus according to claim 1, wherein the processor is configured to execute distributing a connection destination of a path set between the first storage system and the first node to a plurality of ports of a plurality of nodes of the first storage system.

13. The management apparatus according to claim 1, wherein the processor is configured to execute arranging a plurality of units of copy such that processing performance necessary for copying in units of copy arranged in each node in each node of the second storage system is lower than or equal to performance of each node, and setting a path between each node and the first storage system.

14. A path setting method performed by a management apparatus that manages a path between a first storage system and a second storage system in a computer system including the first storage system and the second storage system that is a copy destination of a predetermined unit of copy of the first storage system, wherein
the second storage system includes a first node having a first controller that processes copying in the unit of copy and a second node having a second controller that performs a copy process in place of the first controller when a failure occurs in the first controller, and
the management apparatus is configured to execute:
calculating a necessary number, which is a number of paths necessary for a performance requirement, based on quality of a network between the first storage system and the second storage system and a performance requirement related to a communication amount necessary for copying in the unit of copy; and
setting the necessary number or more of paths between the first storage system and the first node.

15. A path setting program to be executed by a computer that manages a path between a first storage system and a second storage system in a computer system including the first storage system and the second storage system that is a copy destination of a predetermined unit of copy of the first storage system, wherein
the second storage system includes a first node having a first controller that processes copying in the unit of copy and a second node having a second controller that performs a copy process in place of the first controller when a failure occurs in the first controller,
the path setting program causes the computer to execute:
calculating a necessary number, which is a number of paths necessary for a performance requirement, based on quality of a network between the first storage system and the second storage system and a performance requirement related to a communication amount necessary for copying in the unit of copy; and
setting the necessary number or more of paths between the first storage system and the first node.
